(19) United States
(12) Patent Application Publication
(10) Pub. No.: US 2001/0015939 A1
(43) Pub. Date: Aug. 23, 2001

(54) Objective lens for optical pick-up

(75) Inventor: Wataru Kubo, Saitama-ken (JP)

Correspondence Address: GREENBLUM & BERNSTEIN, 1941 ROLAND CLARKE PLACE, RESTON, VA, 20191

(73) Assignee: ASAHI KOGAKU KOGYO KABUSHIKI KAISHA, Tokyo (JP)

(21) Appl. No.: 09/778,079

(22) Filed: Feb. 7, 2001

(30) Foreign Application Priority Data
Feb. 8, 2000 (JP) 2000-029879

(51) Int. Cl. G11B 7/00

(52) U.S. Cl. 369/13

(57) ABSTRACT

The objective lens embodying the invention is a single plano-convex lens that is supported by a fine actuator such that the flat surface faces to the MO disc. The fine actuator drives the objective lens in the optical axis direction to focus the laser beam onto the recording layer of the MO disc. The optical axis of the objective lens is coaxial with the center axis of the laser beam. The objective lens is provided with an outer flange formed around the edge thereof to be held by a lens frame of the fine actuator. The objective lens is made by using compression molding technique, and it is made from glass whose refractive index is higher than 1.6 at wavelengths of the laser beam emitted from the semiconductor laser.

### BACKGROUND OF THE INVENTION

The present invention relates to an objective lens installed in an optical pick-up that is employed for writing digital data on an optical medium or reading the data from an optical medium.

An optical pick-up, which reads recorded data from a optical medium such as a CD (compact disc) or a DVD (digital versatile disc) or writes data on the optical medium, is provided with semiconductor laser that emits a laser beam and an objective lens that converges the laser beam to form a beam spot on a recording layer of the optical medium.

In an optical pick-up designed for a CD, the objective lens has consisted of a single plastic molded lens whose NA (numerical aperture) is relatively low because of low recording density of a CD.

In recent years, there has been various approaches to increase the NA of the objective lens with increasing capacity, i.e., recording density of an optical medium. For instance, Japanese provisional patent publication No. Hei 8-315404 discloses a solid immersion lens that is added to a conventional double convex objective lens to increase the resultant NA of the optical system including the objective lens and the solid immersion lens. The use of the solid immersion lens in conjunction with the objective lens decreases the spot size of the laser beam focused on the recording medium and therefore increases the recording density.

However, when the objective lens contains a plurality of lens elements as described above, a conventional fine actuator, which drives the objective lens in the optical axis direction, designed for a single objective lens cannot be applied because of over load. Further, the objective lens containing a plurality of lens elements (a multi-element objective lens) requires a lens frame in which the lens elements are fixed, and the optical axes of the lens elements must be aligned to each other in the lens frame, which increases a number of manufacturing steps, increasing a cost. Moreover, in the multi-element objective lens, since the distance between the closest surface to an optical medium and a principle point at the side of the optical medium becomes larger as compared with that in the single objective lens, a working distance becomes shorter.

In view of the disadvantages of the multi-element objective lens, it is preferable to increase the NA of a single objective lens. However, such a objective lens has not been realized. There are several reasons: (1) since curvatures of both surfaces become large to keep a high NA, the wavefront aberration of the objective lens tends to sharply increases with a temperature change, (2) it is difficult to align the axes of the molding dies during the molding process, which reduces production yield.

### SUMMARY OF THE INVENTION

It is therefore an object of the present invention to provide a single objective lens for an optical pick-up, which is capable of increasing a NA without increasing a wavefront aberration and tolerance of an alignment of molding dies during a molding process.

For the above object, according to the present invention, there is provided an improved objective lens for an optical pick-up, which includes a single glass plano-convex lens having a convex surface at the incident side of the parallel light beam and a flat surface at the side of the optical medium, thereby keeping numerical aperture not less than 0.7.

Since refractive index of glass is higher than plastic, the curvatures of the surfaces become smaller than that of a plastic lens with keeping a constant refractive power. Therefore, the plano-convex single lens achieves the high NA not less than 0.7. Further, since variations in the shape and the refractive index of a glass lens due to a temperature change or a humidity change are also smaller than a plastic lens and the curvature of the convex surface is relatively small, it is easier to keep the wavefront aberration low even if temperature and/or humidity changes.

The plano-convex lens is free from the problem of a decentering tolerance (a parallel shift between the vertical axes at the tops of the molding dies), which extensively increases the production yield. Further, since the weight and the size of the objective lens according to the invention is substantially the same as the conventional single objective lens, a conventional fine actuator designed for a single objective lens can drive the objective lens of the invention.

In the present invention, the larger the refractive index of the glass the better. For instance, the refractive index is preferably larger than 1.6. However, since a refractive index of an optical glass is larger than that of a plastic, the object of the invention can be achieved even if the refractive index is smaller than 1.6.

The objective lens of an optical pick-up according to the present invention can be applied to writing digital data to an optical medium or to reading data therefrom. The optical pick-up may be designed for a read-only system such as a CD system and a LD (laser disc) system, a magneto-optical system, a phase modulation writing system or a WORM (write-once, read-many-times) system.

### DESCRIPTION OF THE ACCOMPANYING DRAWINGS

FIG. 1 is a perspective view of an optical disc apparatus that employs an objective lens of an optical pick-up embodying the invention;

FIG. 2 is a sectional view of the objective lens and a fine actuator of the optical pick-up of FIG. 1;

FIG. 3 is a sectional view of the objective lens and a fine actuator of an optical pick-up of a modified example;

FIG. 4 is a lens diagram of the objective lens according to a first embodiment;

FIG. 5A is a graph showing a spherical aberration and a sine condition of the objective lens according to the first embodiment;

FIG. 5B is a graph showing chromatic aberration represented by spherical aberrations at 645 nm, 655 nm and 665 nm of the objective lens according to the first embodiment;

FIGS. 6A and 6B are graphs showing the aberrations shown in FIGS. 5A and 5B while the scale of the horizontal axes are ten times larger than FIGS. 5A and 5B;

FIGS. 7A, 7B and 7C show wavefront aberrations of the objective lens according to the first embodiment in a meridional plane;

FIGS. 8A, 8B and 8C show wavefront aberrations of the objective lens according to the first embodiment in a sagital plane;

FIG. 9 is a lens diagram of the objective lens according to a second embodiment;

FIG. 10A is a graph showing a spherical aberration and a sine condition of the objective lens according to the second embodiment;

FIG. 10B is a graph showing chromatic aberration represented by spherical aberrations at 645 nm, 655 nm and 665 10 nm of the objective lens according to the second embodiment;

FIGS. 11A and 11B are graphs showing the aberrations shown in FIGS. 10A and 10B while the scale of the horizontal axes are ten times larger than FIGS. 10A and 10B;

FIGS. 12A, 12B and 12C show wavefront aberrations of the objective lens according to the second embodiment in a meridional plane;

FIGS. 13A, 13B and 13C show wavefront aberrations of the objective lens according to the second embodiment in a sagital plane;

FIG. 14 is a lens diagram of the objective lens according to a third embodiment;

FIG. 15A is a graph showing a spherical aberration and a sine condition of the objective lens according to the third embodiment;

FIG. 15B is a graph showing chromatic aberration represented by spherical aberrations at 640 nm, 650 nm and 660 nm of the objective lens according to the third embodiment;

FIGS. 16A and 16B are graphs showing the aberrations shown in FIGS. 15A and 15B while the scale of the horizontal axes are ten times larger than FIGS. 15A and 15B;

FIGS. 17A, 17B and 17C show wavefront aberrations of the objective lens according to the third embodiment in a meridional plane;

FIGS. 18A, 18B and 18C show wavefront aberrations of the objective lens according to the third embodiment in a sagital plane;

FIG. 19 is a lens diagram of the objective lens according to a fourth embodiment;

FIG. 20A is a graph showing a spherical aberration and a sine condition of the objective lens according to the fourth embodiment;

FIG. 20B is a graph showing chromatic aberration represented by spherical aberrations at 400 nm, 405 nm and 410 nm of the objective lens according to the fourth embodiment;

FIGS. 21A and 21B are graphs showing the aberrations shown in FIGS. 20A and 20B while the scale of the horizontal axes are ten times larger than FIGS. 20A and 20B;

FIGS. 22A, 22B and 22C show wavefront aberrations of the objective lens according to the fourth embodiment in a meridional plane; and

FIGS. 23A, 23B and 23C show wavefront aberrations of the objective lens according to the fourth embodiment in a sagital plane.

### DESCRIPTION OF THE PREFERRED EMBODIMENTS

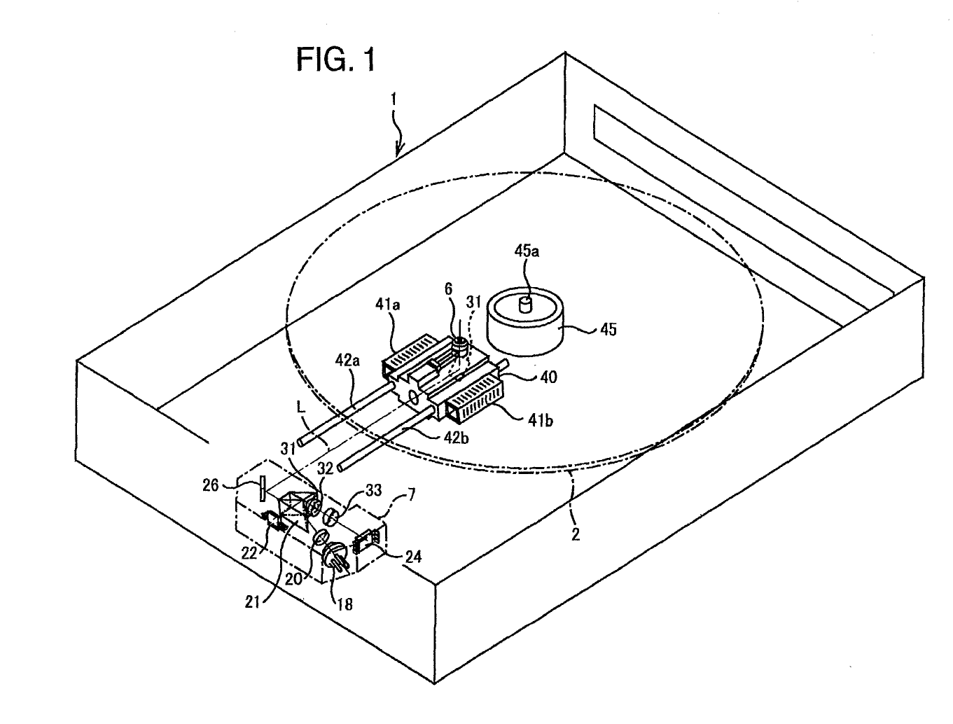

An objective lens of an optical pick-up embodying the invention will be described with reference to the drawings. FIG. 1 is a perspective view of an optical disc apparatus 1 for a MO (magneto-optical) disc 2 that employs an objective lens embodying the invention.

The optical disc apparatus 1 is provided with a spindle motor 45 that rotates the MO disc 2 attached on a spindle 45a, a carriage 40 that is supported by a pair of guide rails 42a, 42b, and a light source module 7 that emits a parallel laser beam. A symbol L represents the center axis of the laser beam.

In the light source module 7, a divergent laser beam emitted from a semiconductor laser 18 is collimated by a collimator lens 20, and the parallel laser beam is adjusted in its sectional shape by a composite prism 21. The laser beam passing through the composite prism 21 is reflected by a galvano mirror 26 to be directed to the carriage 40.

The carriage 40 is driven in the radial direction of the MO disc 2 by linear motors that are constructed from a pair of coils 41a, 41b mounted on the carriage 40 and permanent magnets (not shown). The parallel laser beam incident on an opening of the carriage 40 is reflected by a mirror 31 mounted on the carriage 40 and then the laser beam is converged onto the MO disc 2 through an objective lens 6.

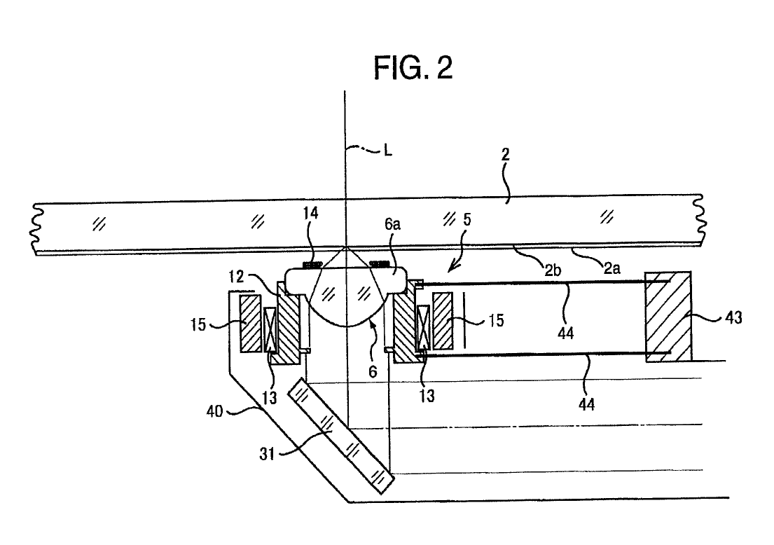

As shown in FIG. 2, the objective lens 6 is a single plano-convex lens that is supported by a fine actuator 5 such that the flat surface faces to the MO disc 2. The optical axis of the objective lens 6 is coaxial with the center axis L of the laser beam. The objective lens 6 is provided with an outer flange 6a formed around the edge thereof to be held by a lens frame 12 of the fine actuator 5. The lens frame 12 is linked to a fixing portion 43 of the carriage 40 through four supporting wires 44. The lens frame 12 can move in the optical axis direction because of elasticity of the supporting wires 44.

A focusing coil 13 is attached around the lens frame 12 and permanent magnets 15 are fixed to the carriage 40 such that they face the focusing coil 13 with predetermined air gap. The linear motor, which is constructed from the focusing coil 13 and the permanent magnet 15, drives the lens frame 12 so that the laser beam converges onto a recording layer 2b of the MO disc 2 through a cover layer 2a. A magnetic coil 14 is attached on the flat surface of the objective lens 6. The magnetic coil 14 applies a magnetic field to the convergent point of the laser beam on the MO disc 2 when the optical pick-up writes digital data.

The laser beam reflected from the MO disc 2 returns to the light source module 7. A part of the reflected beam is separated from the optical path of the incident laser beam from the semiconductor laser 18 by the composite prism 21 to be incident on a data sensor 24 through a Wollaston prism 31, a hologram plate 32 and a condenser lens 33.

In a data writing mode, the semiconductor laser 18 is modulated by recording signals to intermittently emit the laser beam with high power. In the same time, the magnet coil 14 applies the magnetic field to the recording layer 2b of the MO disc 2. The point on the recording layer 2b where the beam spot is converged is heated above its transition temperature and switched in the direction of the magnetization according to the applied magnetic field.

In a data reading mode, the semiconductor laser 18 is controlled to continuously emit the laser beam with low power. The magnetic coil 14 does not apply a magnetic field. Reading of the recording layer 2b is determined by the magneto-optic effect; i.e., the rotation of the plane of polarization by magnetism. The recorded signal is reproduced from the output of the data sensor 24.

A part of the laser beam emitted from the semiconductor laser 18 is divided by the composite prism 21 to be incident on a monitor sensor 22. A control circuit (not shown) controls the semiconductor laser 18 according to the signal from the monitor sensor 22. Further, on the basis of the signals from the data sensor 24, the control circuit controls the galvano mirror 26 for tracking servo and the focusing coil 13 for focusing servo.

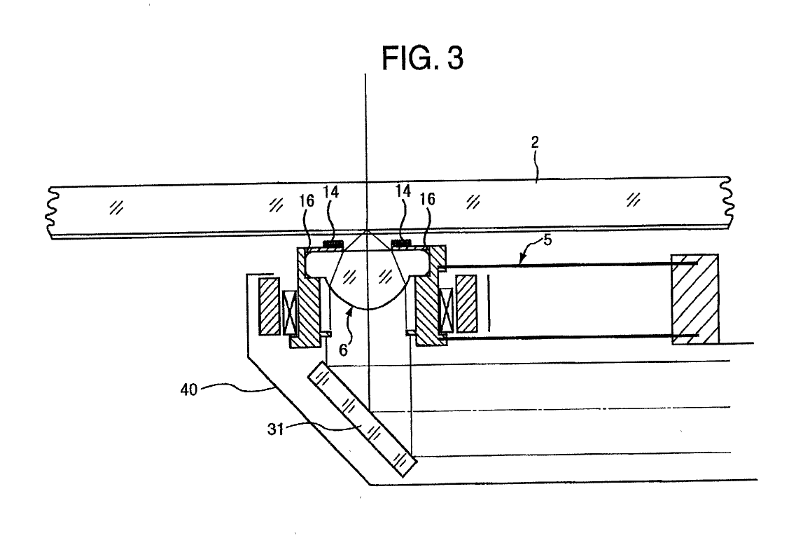

FIG. 3 is a sectional view of the objective lens 6 and the fine actuator 5 of the carriage 40 of a modified example. In this example, the magnetic coil 14 is mounted on a ring-shaped spacer plate 16 that is attached on the flat surface of the objective lens 6.

Next, the construction of the objective lens 6 will be described.

The objective lens 6 is made by using compression molding technique, which enables mass-production of the objective lens 6 with low cost. Further, since the spherical aberration of the plano-convex objective lens varies depending on the thickness thereof, the design of the objective lens can be easily changed according to the thickness of the cover layer of an optical disc. That is, since the spherical aberration of the optical system including the objective lens and the cover layer of the optical disc varies as the thickness of the cover layer changes or the thickness of the objective lens changes, the thickness of the objective lens can be determined to cancel the spherical aberration of the optical system.

In the molding process using a pair of molding dies, the dies should be positioned with a fine inclination tolerance (an inclination between vertical axes at the tops of the molding dies) and a fine decentering tolerance (a parallel shift between the vertical axes) when the objective lens 6 is a double convex lens.

However, since the one surface of the objective lens 6 is a flat surface whose vertical axis may be located at anywhere, it is free from the problem of the decentering tolerance, which extensively increases the production yield. Further, since a curved surface whose radius of curvature is equal to a few hundred millimeters can be regarded as a flat surface, the decentering tolerance becomes almost no problem when one surface is formed as such a curved surface.

Since the flat surface has no refractive power, the refractive power of the convex surface should be large to obtain the NA more than 0.7. The larger the refractive index is, the greater the refractive power is with constant curvature. In the same manner, the larger the curvature is, the greater the refractive power is with constant refractive index.

If the objective lens 6 is made from plastic whose refractive index is about 1.5, the curvature of the convex surface becomes too large to keep the edge thickness required for forming the outer flange 6a on the precondition that the lens thickness is constant. Further, since the incident angle of the marginal ray becomes extensively large, minuscule shape error of the convex surface generates enormous wavefront aberration. Particularly, since variations in the shape and the refractive index of a plastic lens due to a temperature change or a humidity change are relatively large, a plastic lens tends to generate the wavefront aberration.

Therefore, the objective lens 6 is made from glass whose refractive index is higher than 1.6 at wavelengths of the laser beam emitted from the semiconductor laser 18. Since a glass lens has higher moisture resistance and a lower thermal expansion coefficient than a plastic lens, variations in the shape and the refractive index due to a temperature change or a humidity change are small. Further, the higher the refractive index is, the larger the refractive power is with a constant curvature of the convex surface. Since the refractive index of the objective lens 6 is higher than 1.6, the required refractive power (i.e., the required NA not less than 0.7) is achieved with a small curvature of the convex surface, which keeps the incident angle of the marginal ray small. As a result, the wavefront aberration can be kept low even if temperature or humidity changes and the predetermined edge thickness can be kept on the precondition that the lens thickness is constant.

Since the objective lens 6 is a single plano-convex lens without employing an additional lens such as the solid immersion lens, the weight and the size of the objective lens 6 is substantially the same as the conventional single objective lens, which enables use of a conventional fine actuator designed for a single objective lens. Further, the working distance becomes relatively large, which allows the magnetic coil 14 to be located between the objective lens 6 and the MO disc 2. As a result, when the apparatus employs one set of the optical pick-up and the magnetic coil, it can be slim as compared with an apparatus where the optical pick-up and the magnetic coil are separated at both sides of the disc, and when the apparatus employs two sets, it can read/write both sides of the MO disc 2 at the same time. A long working distance offers an advantage of protecting the objective lens 6 and the MO disc 2 to keep the objective lens 6 from contact with the MO disc 2.

The NA of the objective lens 6 is not less than 0.7 that is adequate for forming a small beam spot to increase the recording density.

Four embodiments according to the above mentioned objective lens 6 will be described hereinafter.

First Embodiment

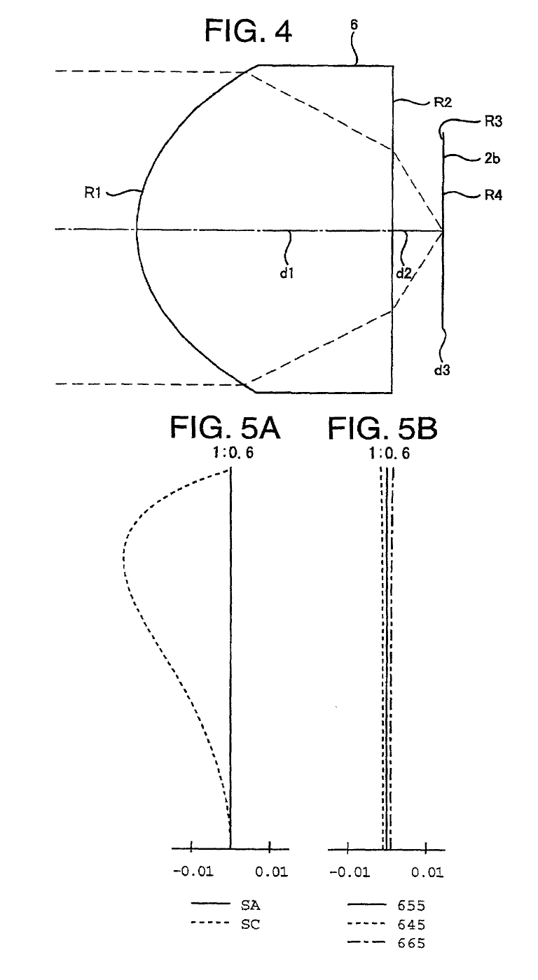

FIG. 4 shows the objective lens 6 of the first embodiment and the recording layer 2b of the MO disc 2, however the outer flange 6a is not illustrated. The numerical constructions of the first embodiment are described in TABLE 1. The values are standardized assuming that the focal length of the objective lens 6 is “”.

The surface number R1 represents the convex surface of the objective lens 6 at the side of the light source portion 7, R2 represents the flat surface at the side of the MO disc 2, R3 and R4 represent the cover layer 2a of the MO disc 2. In TABLE 1, F_{NO}, f, ω and NA denote a F-number, a focal length, a half view angle (unit: degree) and a numerical aperture, respectively. Further, r denotes a radius of curvature of a surface (the values at the vertex for aspherical surface), d denotes a distance between the surfaces along the optical axis, nλ denotes a refractive index at a wavelength λ nm, νd denotes an Abbe number and nd denotes a refractive index at d-line (588 nm).

The convex surface whose surface number is R1 is a rotationally-symmetrical aspherical surface. The rotationally-symmetrical aspherical surface is expressed by the following equation:

$$X ( h ) = \frac{{h}^{2} c}{1 + \sqrt{1 - ( 1 + K ) {h}^{2} {c}^{2}}} + {A}_{4} {h}^{4} + {A}_{6} {h}^{6} + … + {A}_{28} {h}^{28} + {A}_{30} {h}^{30}$$

X(h) is a sag, that is, a distance of a curve from a tangential plane at a point on the surface where the height from the optical axis is h. Symbol c is a curvature (1/r) of the vertex of the surface, K is a conic constant, A₄, A₆, . . . A₂₈ and A₃₀ are aspherical surface coefficients of fourth, sixth, . . . eighth and thirtieth orders (even orders), respectively. The constant K and coefficients A₄ through A₃₀ are shown in TABLE 2.

TABLE 1
F_{NO} = 1:0.6 f = 1.00 ω = 0.4 NA = 0.85

| Surface | | | | | |
|---|---|---|---|---|---|
| number | r | d1 | n655 | νd | nd |
| R1 | 0.796 | 1.318 | 1.79623 | 25.4 | 1.80518 |
| R2 | ∞ | 0.265 | — | — | — |
| R3 | ∞ | 0.002 | 1.48924 | 57.4 | 1.49176 |
| R4 | ∞ | — | — | — | — |

TABLE 2

| | | | | | |
|---|---|---|---|---|---|
| K | −5.00 × | A₁₂ | −3.14129 × | A₂₂ | −1.85017 |
| | 10⁻¹ | | 10⁻¹ | | |
| A₄ | 1.82306 × | A₁₄ | 6.98316 × | A₂₄ | 3.61055 × |
| | 10⁻² | | 10⁻¹ | | 10⁻¹ |
| A₆ | −3.94770 × | A₁₆ | −1.22645 | A₂₆ | 1.36937 |
| | 10⁻⁴ | | | | |
| A₈ | −3.19067 × | A₁₈ | 8.99044 × | A₂₈ | −8.45435 × |
| | 10⁻² | | 10⁻¹ | | 10⁻¹ |
| A₁₀ | 5.67352 × | A₂₀ | 7.65879 × | A₃₀ | 8.47183 × |
| | 10⁻² | | 10⁻¹ | | 10⁻³ |

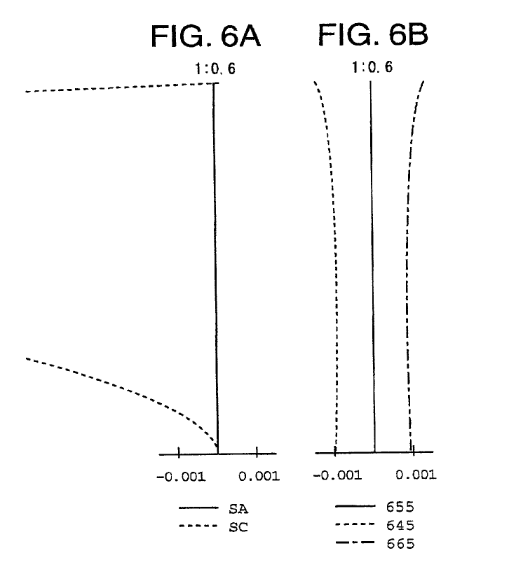

FIG. 5A is a graph showing a spherical aberration SA (solid line) and a sine condition SC (dotted line) of the objective lens 6 of the first embodiment, and FIG. 5B is a graph showing chromatic aberration represented by spherical aberrations at 645 nm (dotted line), 655 nm (solid line) and 665 nm (alternate long and short dash line). The vertical axes denotes the F-number whose maximum value is 0.6 and the horizontal axes denotes amounts of the aberrations. FIGS. 6A and 6B are graphs showing the aberrations shown in FIGS. 5A and 5B while the scale of the horizontal axes are ten times larger than FIGS. 5A and 5B. These graphs show that the objective lens 6 of the first embodiment is well corrected in the spherical aberration at the wavelength 655 nm.

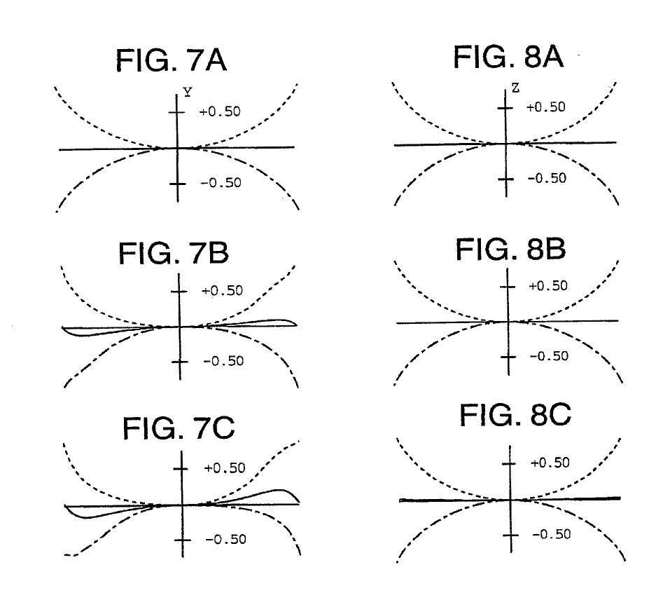

Further, each of FIGS. 7A, 7B and 7C shows a wavefront aberration of the objective lens 6 of the first embodiment in a meridional plane, i.e., a relationship between an pupil coordinate (horizontal axis) of rays on an exit pupil and the wavefront aberration (vertical axis) in a meridional plane. FIG. 7A shows the wavefront aberration of the rays converged onto the optical axis on the image plane (the recording layer 2b), FIG. 7B shows that of the rays converged onto the point whose image height Y=−0.003, FIG. 7C shows that of the rays converged onto the point whose image height Y=−0.006.

In the same manner, FIGS. 8A, 8B and 8C show wavefront aberrations of the objective lens 6 of the first embodiment in a sagital plane; FIG. 8A shows the wavefront aberration of the rays converged onto the optical axis on the image plane, FIG. 8B shows that of the rays converged onto the point whose image height Y=−0.003, FIG. 8C shows that of the rays converged onto the point whose image height Y=−0.006.

These graphs show that the objective lens 6 of the first embodiment is well corrected in the wavefront aberration at the wavelength 655 nm and the wavefront aberration is smaller than the Mareshal condition for a diffraction-limited optical system 0.07λ rms. Therefore, the objective lens 6 is adequate for an optical pick-up that reads/writes an optical medium.

Second Embodiment

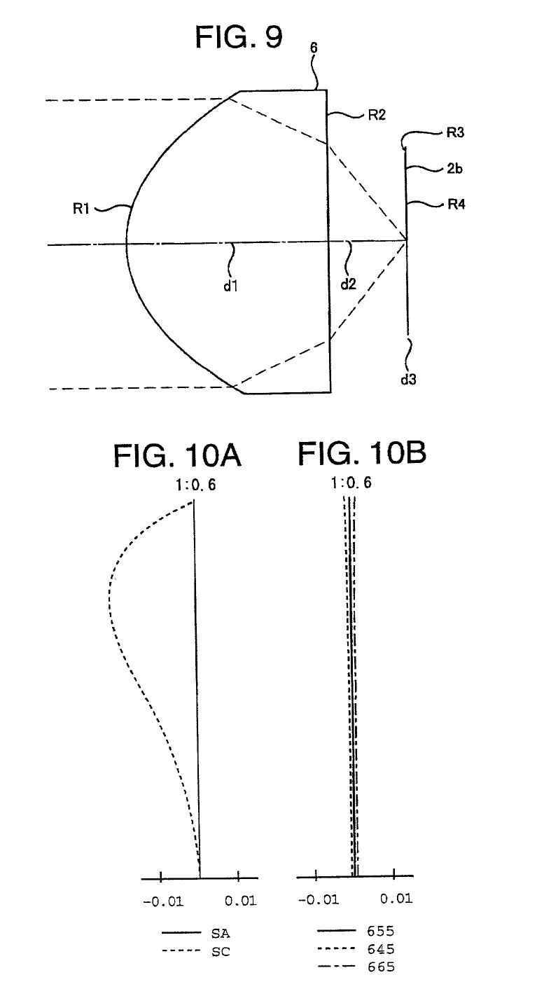

FIG. 9 shows the objective lens 6 of the second embodiment and the recording layer 2b of the MO disc 2, however the outer flange 6a is not illustrated. The numerical constructions of the second embodiment are described in TABLE 3. The values are standardized assuming that the focal length of the objective lens 6 is “1”. The constant K and coefficients A₄ through A₃₀ of the convex surface of the objective lens 6 at the side of the light source module 7 are shown in TABLE 4.

TABLE 3
F_{NO} = 1:0.6 f = 1.00 ω = 0.4 NA = 0.80

| Surface | | | | | |
|---|---|---|---|---|---|
| Number | r | d1 | n655 | νd | nd |
| R1 | 0.723 | 1.041 | 1.72349 | 40.4 | 1.72877 |
| R2 | ∞ | 0.395 | — | — | — |
| R3 | ∞ | 0.001 | 1.48924 | 57.4 | 1.49176 |
| R4 | ∞ | — | — | — | — |

TABLE 4

| | | | | | |
|---|---|---|---|---|---|
| K | −5.00 × 10⁻¹ | A₁₂ | −6.07184 × | A₂₂ | −6.59491 |
| | | | 10⁻¹ | | |
| A₄ | 8.54565 × 10⁻³ | A₁₄ | 1.50238 | A₂₄ | 1.19682 |
| A₆ | −1.66350 × 10⁻² | A₁₆ | −2.99353 | A₂₆ | 6.11512 |
| A₈ | −6.48983 × 10⁻² | A₁₈ | 2.59299 | A₂₈ | −3.73809 |
| A₁₀ | 9.56993 × 10⁻² | A₂₀ | 2.36218 | A₃₀ | −2.48993 × 10⁻¹ |

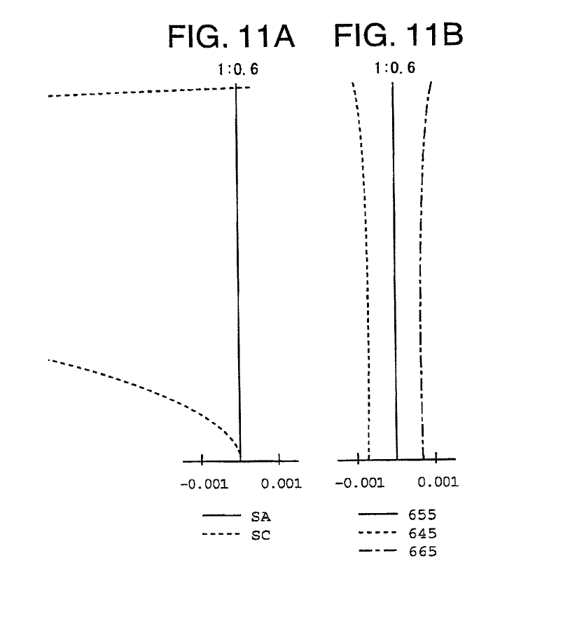

FIG. 10A is a graph showing a spherical aberration SA (solid line) and a sine condition SC (dotted line) of the objective lens 6 of the second embodiment, and FIG. 10B is a graph showing chromatic aberration represented by spherical aberrations at 645 nm (dotted line), 655 nm (solid line) and 665 nm (alternate long and short dash line). FIGS. 11A and 11B are graphs showing the aberrations shown in FIGS. 10A and 10B while the scale of the horizontal axes are ten times larger than FIGS. 10A and 10B. These graphs show that the objective lens 6 of the second embodiment is well corrected in the spherical aberration at the wavelength 655 nm.

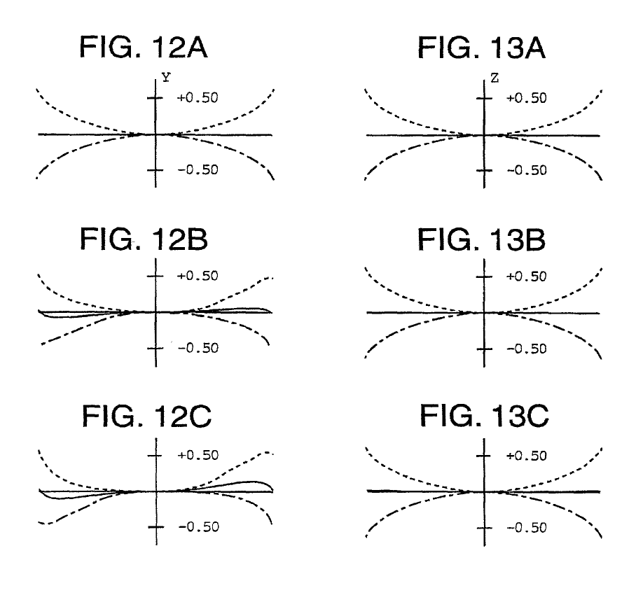

Further, FIGS. 12A, 12B and 12C show wavefront aberrations of the objective lens 6 of the second embodiment in a meridional plane; FIG. 12A shows the wavefront aberration of the rays converged onto the optical axis on the image plane, FIG. 12B shows that of the rays converged onto the point whose image height Y=−0.003, FIG. 12C shows that of the rays converged onto the point whose image height Y=−0.006.

In the same manner, FIGS. 13A, 13B and 13C show wavefront aberrations of the objective lens 6 of the second embodiment in a sagital plane; FIG. 13A shows the wavefront aberration of the rays converged onto the optical axis on the image plane, FIG. 13B shows that of the rays converged onto the point whose image height Y=−0.003, FIG. 13C shows that of the rays converged onto the point whose image height Y=−0.006.

These graphs show that the objective lens 6 of the second embodiment is well corrected in the wavefront aberration at the wavelength 655 nm and the wavefront aberration is smaller than 0.07 rms. Therefore, the objective lens 6 is adequate for an optical pick-up that reads/writes an optical medium.

Third Embodiment

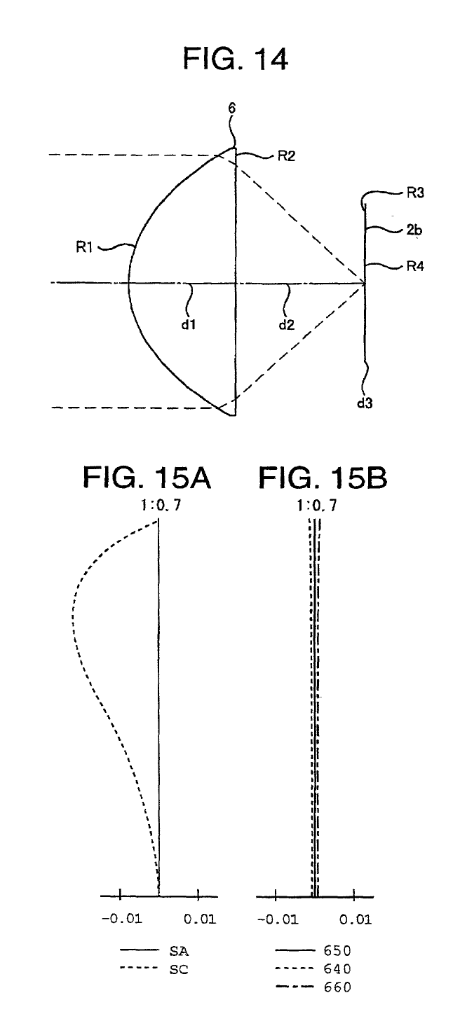

FIG. 14 shows the objective lens 6 of the third embodiment and the recording layer 2b of the MO disc 2, however the outer flange 6a is not illustrated. The numerical constructions of the third embodiment are described in TABLE 5. The values are standardized assuming that the focal length of the objective lens 6 is “1”. The constant K and coefficients A₄ through A₃₀ of the convex surface of the objective lens 6 at the side of the light source module 7 are shown in TABLE 6.

TABLE 5
F_{NO} = 1:0.7 f = 1.00 ω = 0.4 NA = 0.70

| Surface | | | | | |
|---|---|---|---|---|---|
| Number | r | d1 | n650 | νd | nd |
| R1 | 0.635 | 0.549 | 1.63533 | 55.4 | 1.63854 |
| R2 | ∞ | 0.663 | — | — | — |
| R3 | ∞ | 0.001 | 1.48940 | 57.4 | 1.49176 |
| R4 | ∞ | — | — | — | — |

TABLE 6

| | | | | | |
|---|---|---|---|---|---|
| K | −5.00 × | A₁₂ | −2.58345 | A₂₂ | −1.11912 × |
| | 10⁻¹ | | | | 10⁺² |
| A₄ | −2.03911 × | A₁₄ | 8.76825 | A₂₄ | 2.61258 × |
| | 10⁻² | | | | 10⁺¹ |
| A₆ | −6.77764 × | A₁₆ | −2.24795 × | A₂₆ | 1.77283 × |
| | 10⁻² | | 10⁺¹ | | 10⁺² |
| A₈ | −1.77476 × | A₁₈ | 2.55991 × | A₂₈ | −1.41138 × |
| | 10⁻¹ | | 10⁺¹ | | 10⁺² |
| A₁₀ | 3.59555 × | A₂₀ | 3.03661 × | A₃₀ | −1.15063 × |
| | 10⁻¹ | | 10⁺¹ | | 10⁺¹ |

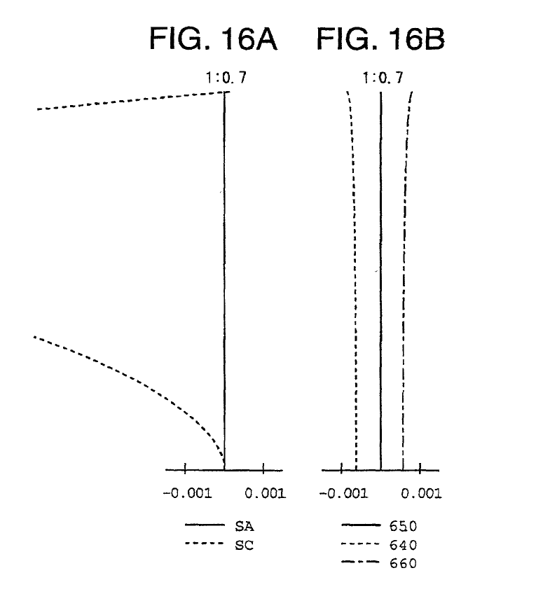

FIG. 15A is a graph showing a spherical aberration SA (solid line) and a sine condition SC (dotted line) of the objective lens 6 of the third embodiment, and FIG. 15B is a graph showing chromatic aberration represented by spherical aberrations at 640 nm (dotted line), 650 nm (solid line) and 660 nm (alternate long and short dash line). FIGS. 16A and 16B are graphs showing the aberrations shown in FIGS. 15A and 15B while the scale of the horizontal axes are ten times larger than FIGS. 15A and 15B. These graphs show that the objective lens 6 of the third embodiment is well corrected in the spherical aberration at the wavelength 650 nm.

Further, FIGS. 17A, 17B and 17C show wavefront aberrations of the objective lens 6 of the third embodiment in a meridional plane; FIG. 17A shows the wavefront aberration of the rays converged onto the optical axis on the image plane. FIG. 17B shows that of the rays converged onto the point whose image height Y=−0.003, FIG. 17C shows that of the rays converged onto the point whose image height Y=−0.006.

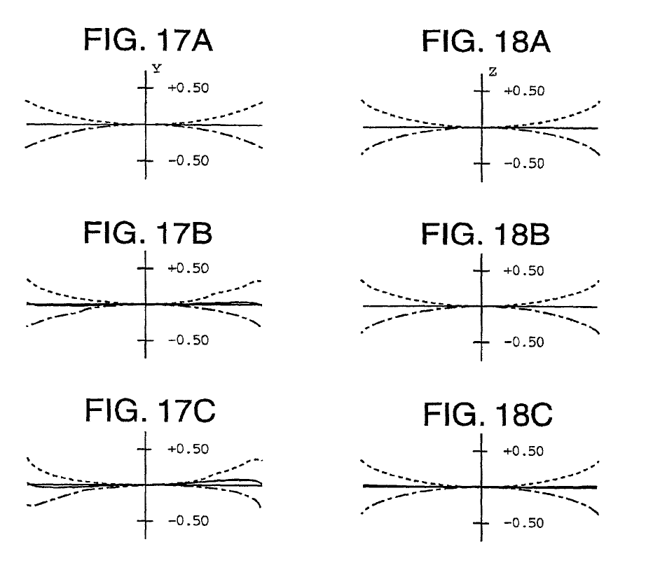

In the same manner, FIGS. 18A, 18B and 18C show wavefront aberrations of the objective lens 6 of the third embodiment in a sagital plane; FIG. 18A shows the wavefront aberration of the rays converged onto the optical axis on the image plane, FIG. 18B shows that of the rays converged onto the point whose image height Y=−0.003, FIG. 18C shows that of the rays converged onto the point whose image height Y=−0.006.

These graphs show that the objective lens 6 of the third embodiment is well corrected in the wavefront aberration at the wavelength 650 nm and the wavefront aberration is smaller than 0.07 λrms. Therefore, the objective lens 6 is adequate for an optical pick-up that reads/writes an optical medium.

Fourth Embodiment

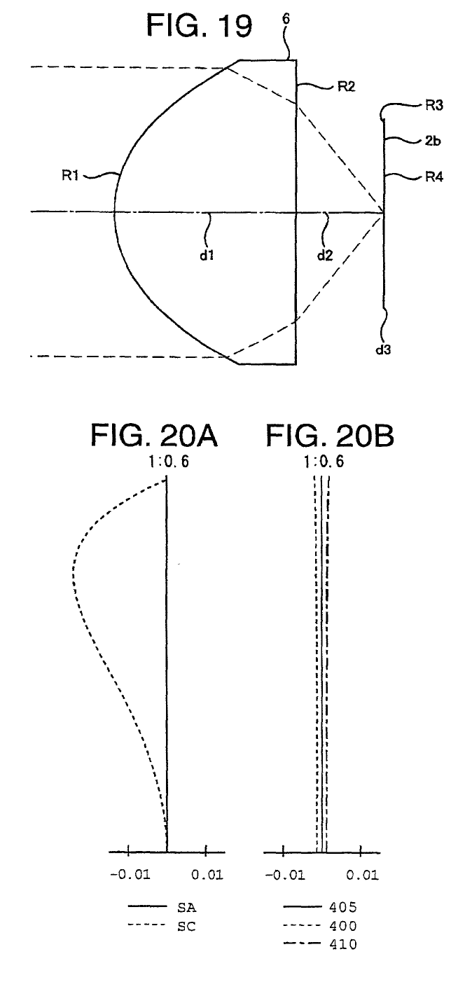

FIG. 19 shows the objective lens 6 of the fourth embodiment and the recording layer 2b of the MO disc 2, however the outer flange 6a is not illustrated. The numerical constructions of the fourth embodiment are described in TABLE 7. The values are standardized assuming that the focal length of the objective lens 6 is “1”. The constant K and coefficients A₄ through A₃₀ of the convex surface of the objective lens 6 at the side of the light source module 7 are shown in TABLE 8.

TABLE 7
F_{NO} = 1:0.6 f = 1.00 ω = 0.4 NA = 0.80

| Surface | | | | | |
|---|---|---|---|---|---|
| Number | r | d1 | n405 | νd | nd |
| R1 | 0.689 | 0.935 | 1.68949 | 55.4 | 1.66910 |
| R2 | ∞ | 0.446 | — | — | — |
| R3 | ∞ | 0.001 | 1.50656 | 57.4 | 1.49176 |
| R4 | ∞ | — | — | — | — |

TABLE 8

| | | | | | |
|---|---|---|---|---|---|
| K | −5.00 × 10⁻¹ | A₁₂ | −6.26847 × | A₂₂ | −6.59413 |
| | | | 10⁻¹ | | |
| A₄ | 4.46750 × 10⁻³ | A₁₄ | 1.48045 | A₂₄ | 1.19801 |
| A₆ | −2.49366 × 10⁻² | A₁₆ | −3.01379 | A₂₆ | 6.10827 |
| A₈ | −7.89342 × 10⁻² | A₁₈ | 2.57962 | A₂₈ | −3.76734 |
| A₁₀ | 7.69065 × 10⁻² | A₂₀ | −2.35708 | A₃₀ | −3.17240 × 10⁻¹ |

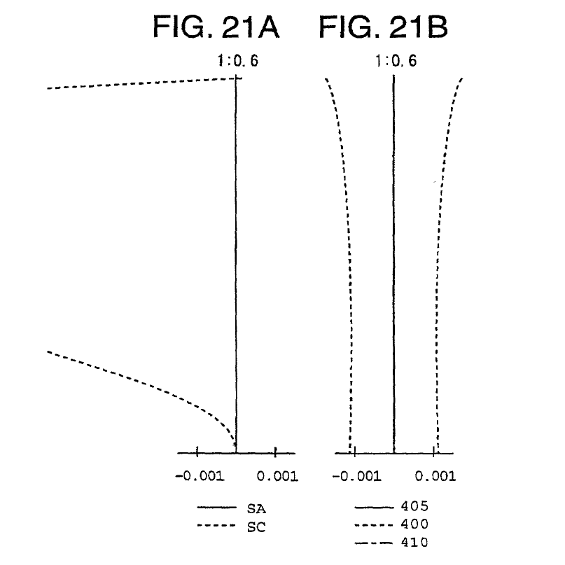

FIG. 20A is a graph showing a spherical aberration SA (solid line) and a sine condition SC (dotted line) of the objective lens 6 of the fourth embodiment, and FIG. 20B is a graph showing chromatic aberration represented by spherical aberrations at 400 nm (dotted line), 405 nm (solid line) and 410 nm (alternate long and short dash line). FIGS. 21A and 21B are graphs showing the aberrations shown in FIGS. 20A and 20B while the scale of the horizontal axes are ten times larger than FIGS. 20A and 20B. These graphs show that the objective lens 6 of the fourth embodiment is well corrected in the spherical aberration at the wavelength 405 nm.

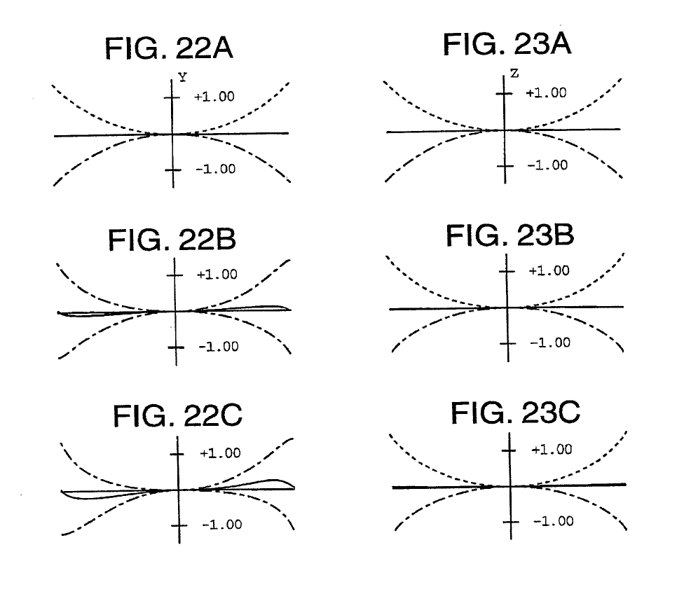

Further, FIGS. 22A, 22B and 22C show wavefront aberrations of the objective lens 6 of the fourth embodiment in a meridional plane; FIG. 22A shows the wavefront aberration of the rays converged onto the optical axis on the image plane, FIG. 22B shows that of the rays converged onto the point whose image height Y=−0.003, FIG. 22C shows that of the rays converged onto the point whose image height Y=−0.006.

In the same manner, FIGS. 23A, 23B and 23C show wavefront aberrations of the objective lens 6 of the fourth embodiment in a sagital plane; FIG. 23A shows the wavefront aberration of the rays converged onto the optical axis on the image plane, FIG. 23B shows that of the rays converged onto the point whose image height Y=−0.003, FIG. 23C shows that of the rays converged onto the point whose image height Y=−0.006.

These graphs show that the objective lens 6 of the fourth embodiment is well corrected in the wavefront aberration at the wavelength 405 nm and the wavefront aberration is smaller than 0.07 λrms. Therefore, the objective lens 6 is adequate for an optical pick-up that reads/writes an optical medium.

The present disclosure relates to the subject matter contained in japanese patent application no. 2000-29879, filed on Feb. 8, 2000, which is expressly incorporated herein by reference in its entirety.

What is claimed is:

1. An objective lens for an optical pick-up that converges a parallel light beam incident thereon onto a recording layer of an optical medium, said objective lens comprising:
a single glass plano-convex lens having a convex surface at the incident side of the parallel light beam and a flat surface at the side of said optical medium, thereby keeping numerical aperture not less than 0.7.

2. The objective lens according to claim 1, wherein the refractive index of said glass is not smaller than 1.6.

3. The objective lens according to claim 1, wherein said plano-convex lens is made through glass molding process with a pair of dies that correspond said convex and flat surfaces, respectively.

4. The objective lens according to claim 1, wherein said plano-convex lens is provided with an outer flange formed around the edge thereof to be held by a fine actuator that drives said plano-convex lens in the optical axis direction.

5. An optical pickup, comprising:
a light source that emits a light beam;
an objective lens that converges said light beam emitted from said light source onto a recording layer of an optical medium, said objective lens comprising a single glass plano-convex lens having a convex surface at the incident side of the parallel light beam and a flat surface at the side of said optical medium, thereby keeping numerical aperture not less than 0.7; and
a magnetic coil for applying a magnetic field to said optical medium, said magnetic coil is arranged on said flat surface of said objective lens.
